(19) United States
(12) Patent Application Publication
(10) Pub. No.: US 2003/0183697 A1
(43) Pub. Date: Oct. 2, 2003

(54) System and method for automated, wireless short range reading and writing of data for interconnected mobile systems, such as reading/writing radio frequency identification (RFID) tags on trains

(76) Inventor: Jeffrey Wayne Porter, Albuquerque, NM (US)

Correspondence Address: BLANK ROME LLP, 600 NEW HAMPSHIRE AVENUE, N.W., WASHINGTON, DC, 20037, US

(21) Appl. No.: 09/570,772

(22) Filed: May 11, 2000

(51) Int. Cl. G06K 19/06

(52) U.S. Cl. 235/492

(57) ABSTRACT

A system and corresponding method include an RF tag coupled to a communications backbone running through a mobile system such as a train. The communications backbone can form part of an electrically controlled pneumatic braking system of the train, which includes a head end unit in the locomotive, and car control units in each railcar of the train. The RF tag includes a communications unit that permits data exchange between the head end unit and other tags within the train, via the communications backbone. The RF tag also includes a processor and an application specific integrated circuit (ASIC) having memory for storing data therein. The RF tag furthermore includes an antenna to permit the tag to exchange data wirelessly with external readers, such as hand-held readers and wayside readers.

### TECHNICAL FIELD

This invention relates to automated data collection and control systems, such as radio frequency identification (RFID) systems employed in mobile systems, such as in trains.

### BACKGROUND OF THE INVENTION

A variety of methods exist for tracking and providing information about items, containers or objects. For example, inventory items typically carry printed labels providing information such as serial numbers, price, weight, and size. Some labels include data carriers in the form of machine-readable symbols that can be selected from a variety of machine-readable symbologies, such as bar code or area code symbologies. The amount of information that the symbols can contain is limited by the space constraints of the label. Updating the information in these machine-readable symbols typically requires the printing of a new label to replace the old.

Data carriers such as memory devices provide an alternative method for tracking and providing information about items. Memory devices permit the linking of large amounts of data with an object or item. Memory devices typically include a memory and logic in the form of an integrated circuit (“IC”) and means for transmitting data to and/or from the device. For example, an RFID tag typically includes a memory for storing data, an antenna, a RF transmitter, and/or a RF receiver to transmit data, and logic for controlling the various components of the memory device. RFID tags are generally formed on a substrate and can include, for example, analog RF circuits and digital logic and memory circuits. U.S. Pat. Nos. 4,739,328 and 5,030,807 describe basic structure and operation of RFID tags.

RFID tags can be either passive or active devices. Active devices are self-powered, by a battery for example. Passive devices do not contain a discrete power source, but derive their energy from a RF signal used to interrogate the RFID tag. Passive RFID tags usually include an analog circuit that detects and decodes the interrogating RF signal and that provides power from the RF field to a digital circuit in the tag. The digital circuit generally executes all of the data functions of the RFID tag, such as retrieving stored data from memory and causing the analog circuit to modulate the RF signal to transmit the retrieved data. In addition to retrieving and transmitting data previously stored in the memory, the RFID tag can permit new or additional information to be stored in the RFID tag's memory, or can permit the RFID tag to manipulate data or perform some additional functions.

Another form of memory device is an optical tag. Optical tags are similar in many respects to RFID tags, but rely on an optical signal to transmit data to and/or from the tag. Additionally, touch memory devices are available as data carriers, for example touch memory devices from Dallas Semiconductor of Dallas, Tex. Touch memory devices are also similar to RF tags, but require physical contact with a probe to store and retrieve data.

RFID tags are often preferred over optical tags or touch memory devices because RFID tags can be read at a substantial distance from a reader, even when the tag moves rapidly pass the reader. For example, automobiles employ RFID tags in wireless toll road applications. Additionally, RFID tags are employed in railroad trains to provide data about individual cars in a train, and the status of systems in a given railroad car. The Association of American Railroads, Mechanical Division, has published a Standard for Automatic Equipment Identification, Standard S-918-95 (adopted in 1991 and revised in 1995). This standard identifies the requirements for RFID tags and readers employed by trains. The standard also specifies RFID tag data content and format.

The RFID tags on trains store data such as bill of lading data regarding contents of a given railroad car to which the RFID tag is affixed. The tag may also identify the type of railcar, such as a refrigerated car, locomotive, or the end of a train. Intermec Corporation, Amtech Systems Division, developed a high quality monitoring system for trains, marketed as RIDEMASTER, which monitors the ride quality of railcars. RIDEMASTER collects and records impact, internal temperature, and external analog and digital sensor events during a railcar's journey. Regarding impacts, RIDEMASTER records impacts along three perpendicular axes and includes time, date, duration, change of velocity and acceleration in an impact event record. When connected to Amtech's Dynamic Tag, Model No. AT5707, RIDEMASTER can transfer data wirelessly to a wayside or trackside Automatic Equipment Identification (AEI) reader. A remote host computer, coupled to the wayside reader, can then receive and analyze data from RIDEMASTER (or other tags in a train).

If data is to be read from each car, then each car must have not only a RIDEMASTER system, but also a dynamic tag or other transceiver for communicating with the wayside reader. This increases the cost of implementing such an automated data collection system within a train. Additionally, a wayside reader must accurately read each tag as a train passes by, which can be difficult if numerous tags are present, the train is traveling at high speeds, electromagnetic interference is present, etc. Furthermore, RFID tags employed in a train are typically read-only, and thus cannot be easily or dynamically updated during transit.

### SUMMARY OF THE INVENTION

The Association of American Railroads is investigating using electronically controlled pneumatic brake (ECP) system to provide numerous benefits over current pneumatically controlled brakes, such as providing simultaneous braking, shorter stopping distances, uniform braking, and so forth. Details on electronic pneumatic braking systems may be found in, for example, U.S. Pat. No. 5,722,736, and literature produced by Echelon Corporation (http://www.echelon.com). One proposed system employs an IEEE standard P1473 as a communication protocol for trains. A platform for implementing this protocol employs a control network sold under the name LonWorks by Echelon Corporation of Palo Alto, Calif.

The LonWorks network provides a standard, off-the-shelf platform for distributed control systems on trains, which includes a fully defined protocol using: peer-to-peer, event-driven updates; multiple media (e.g., twisted pair cable, existing AC/DC power lines, optical fiber and RF); a standard application-level, object-based architecture for exchanging data among sensors, actuators and controllers in a train; and a standard, scalable, platform-independent client/server network operating system. The LonWorks network, including the protocol, is embodied in a Neuron Chip available from Toshiba Corporation and Motorola Corporation. The LonWorks Network can thus provide a wired communications system within a train that monitors and provides signals to a control station (such as a head end unit in a locomotive) regarding the status of various train functions, including positions of doors for each car in the train (opened or closed), braking control, etc. The LonWorks Network, together with an electrically controlled pneumatic brake system, form an ECP communication wired backbone running through the train.

Under aspects of the invention, existing RFID tags or other automated data collection devices are coupled to the communications backbone to provide automated equipment monitoring, train control, lading information exchange and positive train separation data, both along the backbone and to external readers, such as wayside readers. Currently, RFID tags employed in North American rail systems are used strictly for automated equipment identification (AEI) and asset management. By coupling such RFID tags to the communications backbone, existing AEI equipment and functionality can be extended to identify cargo, owner, destination and time requirements on each car of a train to a head end unit in the locomotive or to external systems via a wayside reader or a satellite communication link. Costs for establishing, maintaining and updating hardware, software and data in existing AEI systems is lowered under aspects of the invention. More data about the status of each railcar, and its contents, can be communicated globally in real time by providing such data from RFID tags to wayside readers or via a satellite communication link. The cost of such data transmission can be reduced in situations where a rail line already includes RFID wayside readers, ECP braking systems and satellite communication links.

In a broad sense, aspects of the invention include an automated data collection apparatus that includes a memory, an antenna and a logic and communications unit. The memory has data stored therein and the logic and communications unit is coupled to the memory, the antenna and to an external communications line. The logic and communications unit provides data exchange between the memory, and the communications line and via the antenna. The communications and logic unit is configured to enable the automated data collection apparatus to exchange data stored in the memory both over the external communications line and via the antenna.

### BRIEF DESCRIPTION OF THE DRAWINGS

FIG. 1 is a partial schematic, partial block diagram of a communication system employing RFID tags in a train under an embodiment of the invention.

FIG. 2 is a block diagram showing a RFID tag having communications circuitry for communicating with the train of FIG. 1.

FIG. 3 is a flowchart showing an overall sequence of steps for creating and employing the RFID tag of FIG. 2.

FIG. 4 is a flowchart showing steps for employing the RF tags of FIG. 2 under an alternative embodiment of the invention.

FIG. 5 is a schematic diagram of a data structure of data stored in the RF tag of FIG. 2.

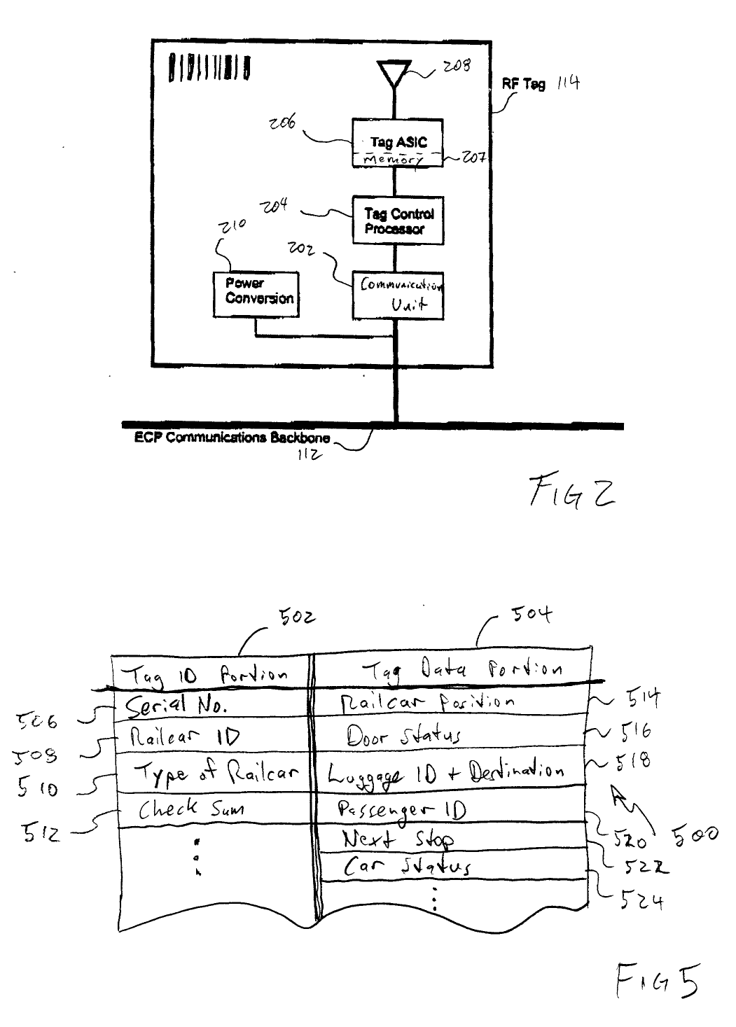

In the drawings, identical reference numbers identify identical or substantially similar elements or steps. To easily identify the discussion of any particular element, the most significant digit or digits in a reference number refer to the figure number in which the element is first introduced (e.g., element 204 is first introduced and discussed with respect to FIG. 2).

### DETAILED DESCRIPTION

The following description provides certain specific details for a thorough understanding of, and enabling description for, various embodiments of the invention. However, one skilled in the art will understand that the invention may be practiced without these details. In other instances, well known structures associated with processors, computing systems, tags, and readers have not been shown or described in detail to avoid unnecessarily obscuring the description of the embodiments of the invention.

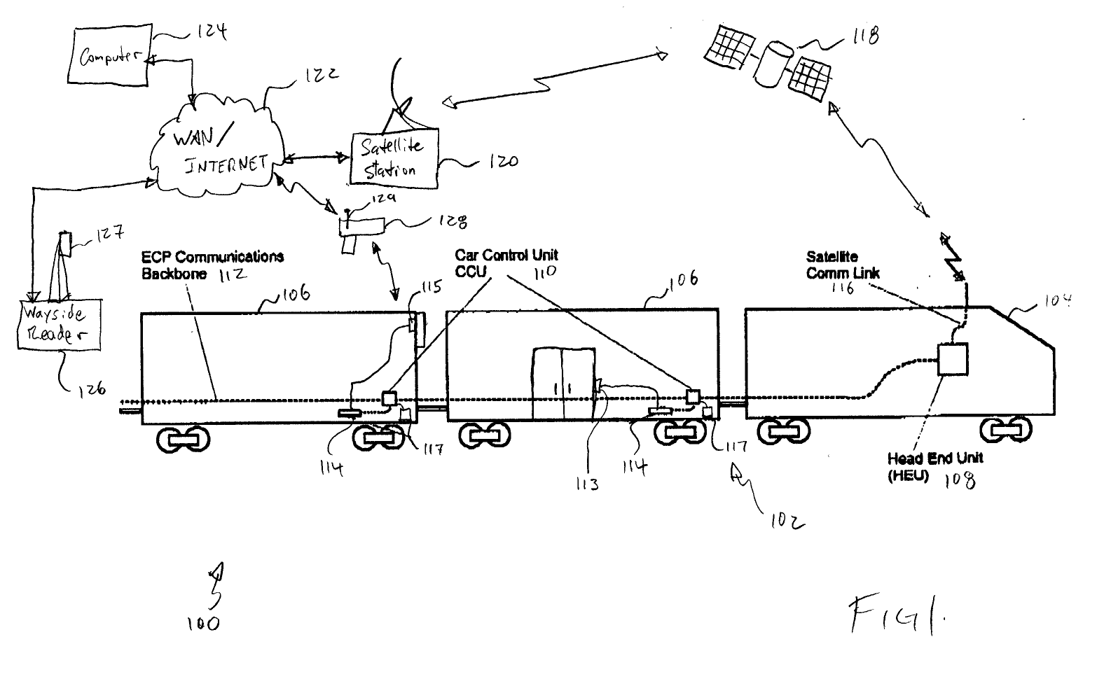

Referring to FIG. 1, a wireless data communication system 100 is shown with respect to a train 102 having a locomotive 104 and two or more railcars 106. The locomotive 104 includes a head end unit (HEU) 108 coupled to one or more car control units (CCU) 110 in each of the railcars 106, by way of a wired electrically controlled pneumatic (ECP) communication backbone 112. The communications backbone 112 runs the length of the train 102, from the locomotive 104 to the end of the train.

Each of the railcars 106 also includes a RFID tag 114, coupled to the communications backbone 112, either directly or through the car control unit 110. The RF tag 114 stores data with respect to the railcar 106 to which it is secured, and provides such data externally by wireless communication, or along the communications backbone 112 to the head end unit 108. The RF tag 114 may store a variety of data, including inventory of items stored within the railcar 106, as described more fully below.

The RF tag 114 may also receive data from sensors positioned within the railcar 106. For example, one of the railcars 106 may include a door sensor 113 that provides a data signal indicating open or closed positions of the door, while another railcar may be a refrigeration car including a refrigeration status sensor 115 to determine and provide a data signal indicating the status of the refrigeration unit. The RF tag 114 may receive such data signals from the sensors 113 and 115 either directly or via the car control unit 110. Similarly, each of the railcars 106 may include an ECP braking system 117, coupled to the car control unit 110, that may similarly provide output signals monitored or stored by the RF tag 114.

Data stored in the RF tags 114 or signals received or monitored by the tags can be relayed to the head end unit 108, over the communications backbone 112, to be transmitted by a satellite communication link 116 to a satellite 118. The signals may in turn then be routed from the satellite 118 to a satellite receiver station 120. One example of a satellite communication link is the STARTRAK system manufactured by STARTRAK Corporation of Morris Plains, N.J. The station 120 includes a computer, communication link and Internet browser software (not shown) to communicate over a wide area network or Internet 122 to a remote computer 124. As a result, data stored in the tags 114 may be relayed from the train 102 to the remote computer 124 in near real time. Of course, while only one remote computer 124 is shown in FIG. 1, the data may be relayed to numerous computers, all of which may be coupled to the Internet 122.

While data stored in the tags 114 may be received by the remote computer 124, the tags may similarly receive data from the computer for storage in the tag. For example, the remote computer 124 may transmit data or commands to the head end unit 108, via the Internet 122, station 120, satellite 118, and communication link 116, and the head end unit in turn transmits the data and commands over the communications backbone 112 to be received by the appropriate RF tag 114 in the appropriate railcar 106. As explained more fully below, each RF tag 114 includes a unique serial number or identifier that is used to transmit data from the head end unit 108 to the appropriate tag over the shared communications backbone 112.

In addition to exchanging data and commands via the satellite 118, data and commands may be exchanged with the RF tags 114 by other means. For example, a wayside reader 126 having an antenna 127 may exchange communications, commands and data signals with an antenna in one or more of the RF tags 114, as described below. The wayside reader 126 in turn is coupled to the Internet 122, and may thereby exchange data and commands between the RF tags 114 and the remote computer 124.

Similarly, a hand-held RF tag reader 128 may wirelessly exchange data and commands with the RF tags 114. The reader 128 includes an antenna 129 to permit the reader to exchange data and commands with the remote computer 124 wirelessly over the Internet 122 or a local area network (LAN) having appropriate wireless base station hardware (not shown). The RF tag 114 may be a “smart label” and include a bar code symbol or other machine-readable symbol formed on an upper or outer surface of the tag. While RF tags are shown and described with respect to FIG. 1, other known memory devices or automatic data collection devices may be employed.

While the reader 128 can communicate with the remote computer 124 via a wireless link, other communication connections are possible. For example, the reader 128 may include a socket (not shown) to permit the reader to connect with a plug coupled directly to the remote computer 124 and thereby provide a wired connection therebetween. The plug can form part of a docking station to permit data exchange as well as battery recharging for the reader 128. Other known methods for communicating between the reader 128 and wayside reader 126, and the remote computer 124 may be employed, as will be appreciated by those skilled in the relevant art. In general, methods and apparatus for exchanging information with RFID tags are well known to those skilled in the relevant art, and thus need not be described in detail herein.

Referring to FIG. 2, the RF tag 114 is shown in more detail. The RF tag 114 includes a communication unit 202 that couples a tag control processor 204 with the communications backbone 112. The processor 204 in turn is coupled to a tag application specific integrated circuit (ASIC), which in turn is connected to an antenna 208. A power source or power converter 210 provides power to the RF tag 114.

The communications unit 202 can be a LonWorks Neuron Chip, or other suitable communication interface. The processor 204 may be any available microprocessor, such as a low power 8-bit processor. The term “processor” as generally used herein includes any logic processing unit, such as one or more central processing units (CPUs), digital signal processors (DSPs), application-specific integrated circuits (ASIC), etc. While the communications unit 202, processor 204, ASIC 206, and other components are shown as separate blocks, some or all of these blocks can be monolithically integrated onto a single chip. If the RF tag 114 is programmed for only simple functions, then the tag control processor 204 may be eliminated and the tag ASIC 206 or communication unit 204 may perform the appropriate data processing functions.

The tag ASIC 206 includes a logic section and a memory 207. The logic section includes an RF receiver and RF transmitter both coupled to the antenna 208. Alternatively, the RF tag 114 may employ separate antennas for both transmission and reception of data. The logic section can include analog circuits comprising the RF receiver and transmitter, and a digital circuit for reading and writing to the memory 207. The digital circuit portion of the logic section generally executes many functions of the RF tag 114, such as retrieving stored data from the memory 207 and modulating the RF signal to transmit the retrieved data via the antenna 208. While discussed in terms of radio frequency, the RF tag 114 can operate in other portions of the electromagnetic spectrum, for example, microwave, optical or light, or infrared.

The power source 210 can be a battery. Alternatively, the power source 210 may draw current from the communications backbone 112, or receive power externally, such as from a RF signal received by the antenna 208.

The memory 207 of the RF tag 114 includes at least two portions or fields: a tag ID portion and a data portion. The tag ID portion provides a serial number or other identifying number for the RF tag 114, which may be a unique number. Additionally, the tag ID portion may include overhead data, including error correction data, manufacturer specific data, industry specific application data, and other data that is generally of a read-only nature. The data portion includes data or commands stored in the tag 114, such as date, time, and information regarding an object or objects to which the tag may be affixed, status of sensors in the railcar 106, etc., as described move fully herein. The data portion typically includes information that may be readily written to under direction of the tag ASIC 206, processor 204, wayside reader 126, hand-held reader 128, head end unit 108, etc., and can include data that is later transferred out of the RF tag 114 over the communications backbone 112.

Unless described otherwise herein, the construction and operation of the various blocks shown in FIG. 2 and the other figures are of conventional design. As a result, such blocks need not be described in great detail herein, as they will be understood by those skilled in the relevant art. Such description is omitted for purposes of brevity and so as not to obscure the detailed description of the invention. Any modifications necessary to the blocks of FIG. 2 or the other figures can be readily made by one skilled in the relevant art based on the detailed description provided herein.

Information regarding systems for automatically reading data from RFID tags, and for controlling or configuring a device such as an RFID reader, can be found in U.S. patent application Ser. No. 09/401,066, filed Sep. 1999, entitled “System And Method For Automatically Controlling Or Configuring A Device, Such As An RFID Reader”, assigned to the assignee of the present invention (Attorney Docket No. 110418272US). Information on RFID tags may be found in, for example, U.S. application Ser. No. 09/067,339, filed Apr. 27, 1998, entitled “Automatic Mode Detection And Conversion System For Printers And Tag Interrogators”, assigned to the same assignee of the present invention (Attorney Docket No. 110418128US2).

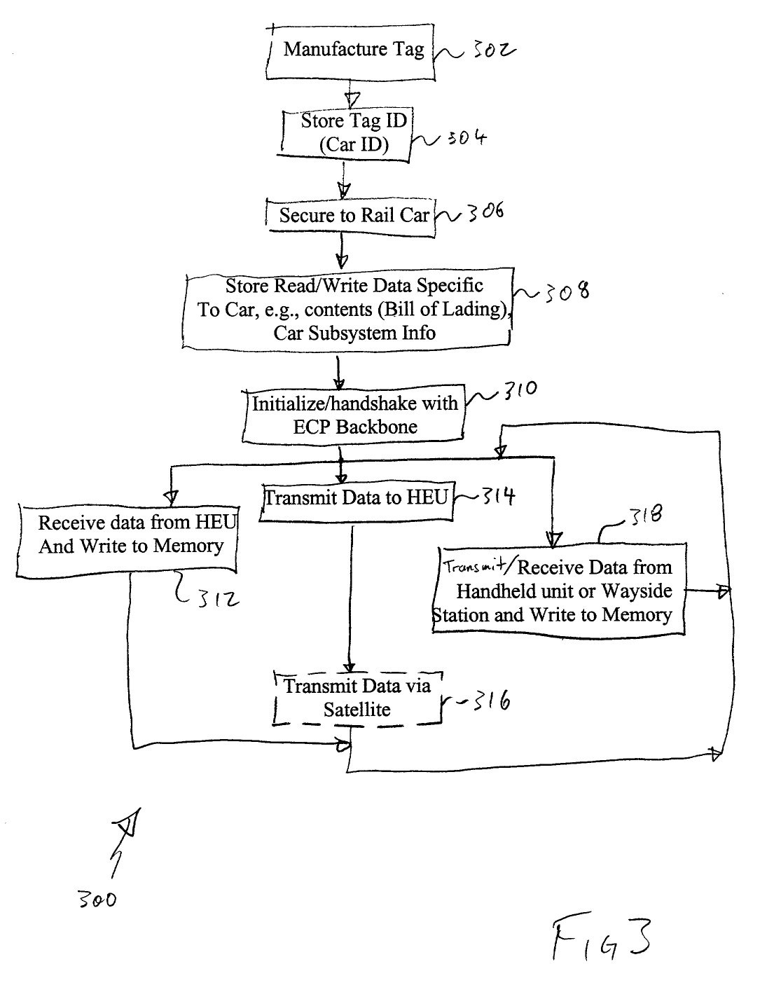

Referring to FIG. 3, a facility or routine 300 shows the basic steps for creating and implementing the RF tag 114. Under step 302, the RF tag 114 is manufactured using known techniques. In step 304, a tag programming system stores permanent or generally read-only data to the RF tag 114, such as a tag ID number and other information, such as information about the railcar 106 to which the tag is to be affixed. Such data typically forms much of the tag ID portion of the memory 207 (FIG. 5). During step 304, a hand-held reader, such as the reader 128, can also store data in the RF tag 114.

In step 306, the RF tag 114 is secured to the selected railcar 106, and electrically or optically coupled to the communications backbone 112. In step 308, the hand-held reader 128, or other suitable device such as the wayside reader 126, writes specific data to the RF tag 114, such as data specific to the current status of the railcar 106. Such data can include: the contents of the car (e.g., a bill of lading); destination and owner/customer data for the railcar or its contents; status of car subsystems, such as output from the door sensor 113, refrigeration sensor 115 and a braking controller 117; etc. In addition to step 304, the reader 128 in step 308 may also store permanent fixed information with respect to the railcar 106, such as a serial number of the car, the position of the car in the train, maintenance information about the railcar, and so forth. Such data, of course, may not necessarily be permanent; instead, this data may be later changed or updated.

In step 310, the communication unit 202 of the RF tag 114 initializes communication with the communications backbone 112, such as by performing any required handshake protocols or other initialization. Such initialization identifies to the head end unit 106 the existence of the RF tag 114 within the train 102. During the initialization under step 310, the RF tag 114 transmits certain other specific data stored in the memory 207 to the head end unit 108, such as the tag ID number, location of the railcar 106 within the train 102, etc.

Following step 310, at least three subroutines may be performed for reading or writing data with respect to the RF tag 114. For example, under a subroutine labeled as box 312, the RF tag 114 receives data from the head end unit 108 via the communications backbone 112. Specifically, the head end unit 108 transmits a packet of data or commands on the communications backbone 112, where such packet includes a header having address information identifying a particular RF tag within the train 102. The address typically includes the unique serial number for the appropriate tag. The communication unit 202 and tag control processor 204 for the particular RF tag 114 recognize the packet on the communications backbone 112 as being addressed to that tag. As an example, the packet may include a write command and appropriate data, that instructs the particular RF tag 114 to write the data to the memory 207 of the RF tag. In response to the instruction, the tag ASIC 206 writes such data to the memory 207.

Under a second subroutine labeled as box 314, the RF tag 114 transmits data stored in the memory 207 to the head end unit 108. Specifically, in response to a command received from the head end unit 108, or in response to preprogrammed instructions to provide regular data (such as time and temperature data for a refrigeration car), the tag ASIC 206 retrieves the desired data from the memory 207, and the communication unit 202 provides such data in a packet addressed to the head end unit 108 over the communications backbone 112. Alternatively, the memory 207 includes preprogrammed instructions for the processor 204, where such instructions command the RF tag 114 to regularly transmit, in a packet, current time and temperature data to the head end unit 108, at specified intervals (e.g, every ten minutes). The head end unit 108 receives packets and thus any data contained therein. The head end unit 108 may thereafter, under an optional step 316, transmit the data to the satellite 118 via the satellite communication link 116.

Under a third subroutine labeled as box 318, the RF tag 114 receives data from the hand-held unit 128 or the wayside reader 126. For example, the hand-held unit 128 performs an initiation protocol to initiate communications with one of the RF tags 114 and provides data to the tag by way of the antenna 208 and tag ASIC 206. In response thereto, the tag ASIC 206 writes the received data to the memory 207. Alternatively, the RF tag 114 transmits data stored in the memory 207 to the wayside reader 126 or hand-held reader 128. Methods of transmitting or receiving data between an RF tag and the wayside reader 126 or hand-held reader 128 are well known and are not described further herein for the sake of brevity.

Unless described otherwise herein, the steps or subroutines described with respect to FIG. 3 and the other Figures and alternatives are well known, or those skilled in the relevant art can create source code subroutines, microcode or program logic arrays or firmware for such steps based on the detailed description provided herein, such as for steps/subroutines 308-318. The steps/subroutines 308-318 can be stored not only in non-volatile memory of the RF tag 114, hand-held reader 128, wayside reader 126 and head end unit 108, but also stored in removable computer-readable media, such as floppy or fixed discs, optical or magnetically readable media, removable cards or chips, etc.

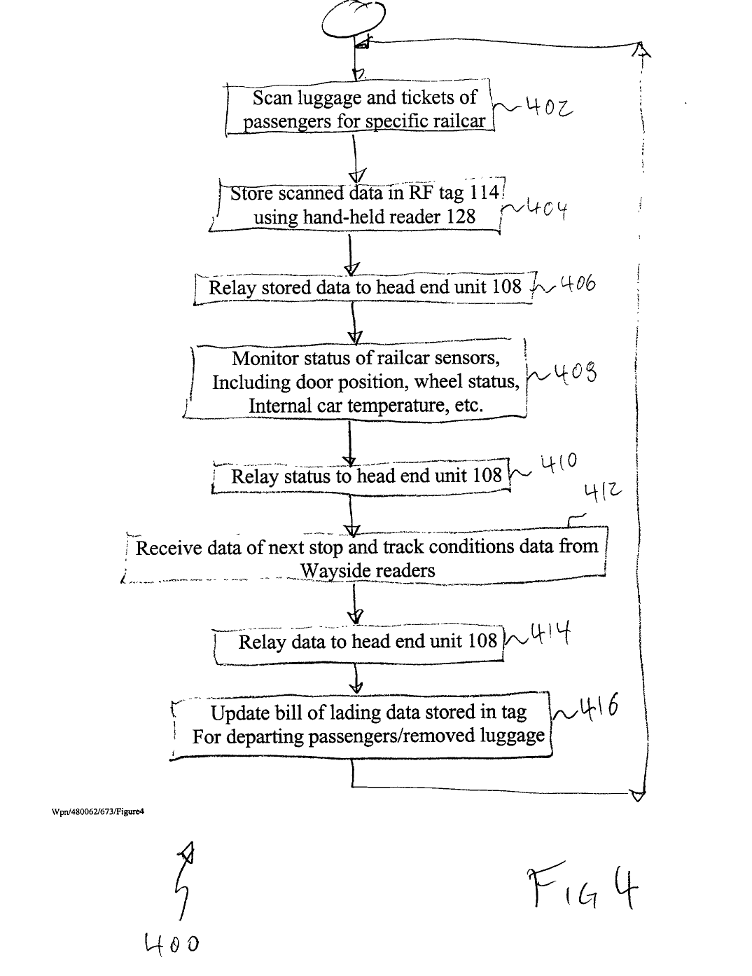

In an alternative embodiment, described below with respect to FIGS. 4 and 5, the train 102 is an automated passenger train that carries passengers and their luggage. This alternative embodiment, and those alternatives and alternative embodiments described herein, are substantially similar to previously described embodiments. Only significant differences in operation or structure are described in detail.

FIG. 5 shows an example of a data structure 500 for data stored in the memory 207 of the RF tag 114. The data structure 500 includes a tag ID portion 502 and a tag data portion 504. The tag ID portion 502 includes typically read-only data initially stored in the RF tag 114 before performing the routine 400 (such as under steps 308 and 310 of routine 300). The tag ID portion 502 includes a tag serial number field 506 that stores a unique serial number for the RF tag 114. The tag ID portion 502 also includes a railcar ID field 508, a type field 510 indicating the type of railcar, a check sum or error correction field 512, and other appropriate data.

The tag data portion 504 includes fields or records that may be often changed during transit. For example, the tag data portion 504 includes a railcar position field 514 indicating a position of the railcar 106 within the train 102.

Referring to FIG. 4, a routine 400 begins in step 402 by scanning machine-readable symbols or other automated data collection devices secured to each passenger's luggage. For example, the reader 128 may include a laser scanner to scan barcode labels affixed to each piece of luggage. Additionally, in step 402, the reader 128 may scan barcodes forming part of each passenger's train ticket. Under step 402, the reader 128 associates each item of luggage of each passenger with one of the railcars 106, such as by exchanging data with the RF tag 114 associated with the railcar, or reading a barcode symbol secured to the car. While step 402 is described above as scanning barcode labels, other methods of automated data collection may be employed, such as imaging two-dimensional symbols using a CCD or other imaging device in the hand-held reader 128. Other automated data collection systems include imaging data produced by invisible, magnetic or electromagnetically recorded inks, or surface formed or biochemically encoded data.

In step 404, the hand-held unit 128 stores the data scanned or otherwise automatically collected under step 402 into the memory 207 of the RF tag 114 for the specific railcar 106. Alternatively, data collected under step 402 may be transmitted via a communication link with the head end unit 108, which in turn transmits the data to the appropriate RF tag 114 over the communication backbone 112. The same process may be performed by means of the wayside reader 126.

Under step 404, the tag ASIC 206 stores such data in a luggage ID and destination record 518 and a passenger ID record 520, both of which form records of the tag data portion 504 of the data structure 500. Each piece of luggage includes an identifier, as well as a destination and other data suitable for luggage. The passenger ID record 520 includes relevant data such as names of passengers, destinations, ticket numbers, price, number of luggage items, and so forth.

Under step 406, the RF tag 114 for the railcar 106 relays data stored in the memory 207 to the head end unit 108 over the communications backbone 112, in a manner similar to that described above with respect to subroutine 314 of FIG. 3.

In step 408, the RF tag 114 monitors the status of sensors in the railcar 106, such as the door sensor 113, whether any wheels, bearings or other subsystems of the railcar are malfunctioning, as well as other environmental data such as internal car temperature and so forth. The RF tag 114 may include a port for directly receiving signals from sensors within the railcar 106, or may receive signals via the car control unit 110. The tag ASIC 206 of the RF tag 114 stores the status of such sensors, typically with a time or clock value, in an appropriate field or record, such as a door status field 516 or a car status record 524.

In step 410, the RF tag 114 relays the status of the railcar sensors to the head end unit 108. For example, under step 410, the head end unit 108 posts a query message on the communication backbone 112 for the specific railcar 106. In response thereto, the RF tag 114 reads the status records, such as the door status field 516 and the car status record 524 in the memory 207, and transmits such data back to the head end unit 108 over the communication backbone 112. Alternatively, the RF tag 114 is preprogrammed to provide such data at predetermined intervals (e.g., every ten minutes).

In step 412, the RF tag 114 receives data from one or more wayside readers 126 (via antenna 208). The wayside readers provide data with respect to track conditions, next destination, and so forth. Track conditions may include information about detours, maintenance on the tracks, or weather conditions. The RF tag 114 stores such data in the memory 207, such as in a next stop field 522 of the data structure 500.

In step 414, the RF tag 114 relays data received from the wayside readers to the head end unit 108. The engineer of the locomotive 104 can then slow the train 102 if relayed data about track maintenance or weather conditions require this. Alternatively, the head end unit 108 and car control units 110 may be preprogrammed to automatically slow the locomotive 104 in response to receiving such data. Additionally, visual displays positioned in each railcar 106 are updated to reflect the next destination. In step 416, the RF tag 114 updates fields or records in the tag data portion 504 based on changes with respect to the specific railcar 106. For example, passengers may depart the train and remove their luggage. The hand-held reader 128 at the passenger's destination (or a fixed reader at the door of the railcar 106) scans their tickets and machine-readable symbols on their luggage, and in turn transmits such change to the RF tag 114 in a manner similar to steps 402 and 404 above. Other data changes, of course, can occur, and appropriate update of data in the RF tag 114 be performed.

The steps of routine 400 are then repeated regularly to refresh or otherwise keep updated data stored in the memory 207 of the RF tag 114. Furthermore, the routine 400 is performed for each RF tag 114 in the train 102. In general, the routine 400 permits a passenger train to effectively be fully automatic.

Although specific embodiments of, and examples for, the invention are described herein for illustrative purposes, various equivalent modifications can be made that are within the spirit and scope of the invention, as will be recognized by those skilled in the relevant art. The teachings provided herein of the invention can be applied to any processor-controlled memory device, not necessarily the RF tag and systems generally described above. For example, the above described embodiments may be modified to incorporate the teachings of the U.S. patents and applications cited above to produce even further embodiments within the scope of the invention.

Additionally, the method and apparatus described in detail above may employ RF tags having smaller memories and even eliminate some of the antennas 208 and processors 204, since functions may be shared between tags along the communications backbone 112. For example, only a few of the RF tags 114 may include the antenna 208 and full circuitry as shown in FIG. 2. Other, smaller RF tags, which may be manufactured at a lower cost, include only a minimum of circuitry and memory capabilities, whereby data stored therein is provided, via the communications backbone 112, to the head in unit 108 or tags having full circuitry as shown in FIG. 2. Such reduced functionality tags, of course, must have minimum communications circuitry to permit memory stored in such tags to be transmitted over the communications backbone 112.

Furthermore, while embodiments of the invention are described above with respect to the train 102, the RF tags 114 and other systems of FIG. 1 may be employed in other environments, such as trucks, ships, and other transportation vehicles. Furthermore, the RF tag 114 is not limited for use in vehicles and other mobile systems, but may be employed in stationary systems, such as a warehouse having containers coupled to a wired communication backbone. In general, the RF tag 114 may be employed in any system of interconnected units having a communication backbone connecting such units.

By providing such a communication backbone 112, not only may data be stored in the memory 207, but new instruction sets and subroutines may be stored in the individual RF tags 114. As a result, such RF tags may be readily upgraded with newer versions of subroutines, or may be dynamically changed to accommodate new communication protocols, and so forth. Moreover, by permitting each RF tag 114 to monitor sensors and other functions of each of the railcars 106, the head end unit 108 receives a real time status of each car in the train 102. By employing the satellite communication link 116, the head end unit 108 may transmit data to the remote computer 124 and allow the remote computer 124 to forecast potential problems with any of the railcars 106 or their associated subsystems, diagnose problems, and automatically correct such problems while the train 102 is in transit.

These and other changes can be made to the invention in light of the above detailed description. In general, in the following claims, the terms used should not be construed to limit the invention to the specific embodiments disclosed in the specification and the claims, but should be construed to include all memory or data collection devices used in various environments that operate in accordance with the claims. Accordingly, the invention is not limited by the disclosure, but instead its scope is to be determined entirely by the following claims.

1. An RFID apparatus for a train, comprising:
a communication line extending through at least one of a plurality of railcars of the train;
an RFID tag coupled to at least a portion of the communications line, wherein the RFID tag is secured to one of the railcars, and wherein the RFID tag includes:
a communications unit coupled to the portion of the communications line and providing data exchange between the RFID tag and the communications line;
an antenna;
a memory having data stored therein; and
a logic circuit coupled to the antenna and to the memory, wherein the logic circuit includes transmit and receive sections configured to enable the tag to respectively transmit and receive data; and wherein the logic circuit is configured to selectively transmit the data stored in the memory both over the communications line and via the antenna.

2. The apparatus of claim 1, further comprising a processor coupled to the communications unit and the logic circuit, wherein the train includes a locomotive having a head end unit coupled to the communications line, wherein the communications unit is coupled, through the communications line, to transmit data packets to the head end unit and to a car control unit located in the one railcar, wherein the head end unit is coupled to a satellite communications system, wherein the RFID tag is configured to exchange data via the satellite communications system over the communications line, and wherein the apparatus further comprises another RFID tag secured to another railcar and coupled to the communications line, and wherein the RFID tag is configured to transmit data to the another RFID tag over the communications line.

3. The apparatus of claim 1 wherein the communications unit, the memory and the logic circuit are monolithically integrated, wherein the RFID tag is coupled to at least one external sensor in the railcar, and wherein the RFID tag receives sensor signals from the external sensor that represent an environmental conditional of the railcar.

4. The apparatus of claim 1, further comprising a wayside reader configured to wirelessly transmit data to and receive data from the antenna of the RFID tag.

5. The apparatus of claim 1 wherein the RFID tag is configured to permit the RFID tag to wirelessly exchange data with a remote computer over a wide area computer network.

6. An automated data collection apparatus, comprising:
a memory having data stored therein;
an antenna; and
a logic and communications unit coupled to the memory, and coupled to an external communications line to provide data exchange between the automated data collection apparatus and the external communications line,
wherein the logic and communications unit is further coupled to the antenna and provides data exchange external to the automated data collection via the antenna, and
wherein the communications and logic unit is configured to enable the automated data collection apparatus to exchange data stored in the memory both over the external communications line and via the antenna.

7. The apparatus of claim 6, further comprising a processor coupled to the logic and communications unit, wherein the automated data collection apparatus is an RFID tag and is secured to a railcar of a train having a locomotive, wherein the locomotive has a head end unit coupled to the communications line, wherein the communications unit is coupled, through the communications line, to the head end unit and to a car control unit located in the railcar, wherein the head end unit is coupled to a satellite communications system, wherein the RFID tag is configured to exchange data via the satellite communications system over the communications line, and wherein the RFID tag is configured to transmit data to another RFID tag in the train over the communications line.

8. The apparatus of claim 6 wherein the logic and communications unit and the memory are monolithically integrated.

9. The apparatus of claim 6 wherein the logic and communications unit is configured to permit the automated data collection apparatus to wirelessly exchange data with a remote computer over a wide area computer network.

10. The apparatus of claim 6, further comprising a processor coupled to the logic and communications unit.

11. The apparatus of claim 6 wherein the automated data collection apparatus is coupled to at least one external sensor and receives and stores in the memory sensor signals from the external sensor.

12. The apparatus of claim 6 wherein the automated data collection apparatus is configured to transmit data to another automated data collection apparatus over the communications line.

13. The apparatus of claim 6 wherein the automated data collection apparatus is configured to transmit data to another automated data collection apparatus over the communications line, wherein the another automated data collection apparatus has less circuitry and functionality than the automated data collection apparatus.

14. The apparatus of claim 6, further comprising a machine-readable symbol secured to the automated data collection apparatus.

15. A method of providing data with respect to an interconnected mobile system, comprising:
storing data in an RFID tag;
securing the RFID tag to a portion of the interconnected mobile system and coupling a communications port of the RFID tag to a communications line in the mobile system; and
transmitting data stored in the RFID tag to a processing unit in the mobile system.

16. The method of claim 15 wherein the interconnected mobile system is a train, wherein the securing the RFID tag includes securing the RFID tag to a railcar of the train, wherein transmitting data includes transmitting data to a head end unit in the train, and wherein the method further comprises receiving data for storage in the RFID tag from the head end unit.

17. The method of claim 15 wherein the method further comprises receiving data for storage in the RFID tag from the processing unit in the mobile system.

18. The method of claim 15 wherein the interconnected mobile system is a train, wherein the securing the RFID tag includes securing the RFID tag to a railcar of the train, wherein transmitting data includes transmitting data to a head end unit in the train, and wherein the method further comprises receiving data for storage in the RFID tag from a wayside or hand-held reader.

19. An automated data collection apparatus, comprising:
memory means for storing data;
antenna means; and
logic and communications means, coupled to the memory and antenna means, and coupled to an external communications line, for providing data exchange between the automated data collection apparatus and the external communications line, and for providing data exchange external to the automated data collection via the antenna means, and
wherein the communications and logic means is configured for enabling the automated data collection apparatus to exchange data stored in the memory means both over the external communications line and via the antenna means.

20. A method of controlling a train, comprising:
providing a train having a head end unit in a locomotive, at least one railcar coupled to the locomotive and having an RF tag, and a communications line extending through a least a portion of the train and intercoupling the RF tag with the head end unit;
at the RF tag, receiving data from at least one wayside reader;
transmitting the received data to the head end unit over the communications line; and
controlling an operation of the train based on the data transmitted over the communications line.

21. The method of claim 20, further comprising:
reading a machine-readable symbol that provides information about a passenger or package;
storing data in the RF tag based on the read machine-readable symbol;
monitoring signals from at least one sensor positioned on the train; and
providing information about the one sensor to the head end unit over the communications line.

22. The method of claim 20, further comprising:
reading a machine-readable symbol that provides information about a passenger or package; and
storing data in the RF tag based on the read machine-readable symbol.

23. The method of claim 20, further comprising:
monitoring signals from at least one sensor positioned on the train; and
providing information about the one sensor to the head end unit over the communications line.

24. The method of claim 20 wherein controlling an operation of the train includes automatically controlling an operation of the train based on the data transmitted over the communications line.

25. A data structure stored in a machine-readable memory usable on a railcar of a train, the data structure comprising:
a tag ID portion containing read-only data identifying the machine-readable memory; and
a tag data portion comprising:
position field indicating a position of the railcar in the train;
a status field indicating a status of at least one sensor in the railcar;
a contents field indicating a contents of the railcar; and wherein data may be written to and read from the fields of the tag data portion.

26. The data structure of claim 25 wherein the tag data portion further comprises:
a next stop field indicating a next stop for the train; and
a door status field indicating a position of the door at a given time.
